(19) United States
(12) Patent Application Publication
(10) Pub. No.: US 2021/0115246 A1
(43) Pub. Date: Apr. 22, 2021

(54) Curable Mixtures for Use in Impregnation of Paper Bushings

(71) Applicant: HUNTSMAN ADVANCED MATERIALS LICENSING (SWITZERLAND) GMBH, Basel (CH)

(72) Inventors: Christian BEISELE, Müllheim (DE); Hubert WILBERS, Schopfheim (DE); Daniel BAER, Riehen (CH)

(73) Assignee: Huntsman Advanced Materials Licensing (Switzerland) GmbH, Basel (CH)

(21) Appl. No.: 16/981,316

(22) PCT Filed: Mar. 14, 2019
(86) PCT No.: PCT/EP2019/056468

§ 371 Date: Sep. 16, 2020

(30) Foreign Application Priority Data
Mar. 16, 2018 (EP) 18162344.8

(51) Int. Cl. C08L 63/00; C08J 5/24; H01B 3/52; H01B 17/58

(52) U.S. Cl. CPC C08L 63/00; C08J 5/24; C08J 2463/00; H01B 17/583; C08J 2363/00; H01B 3/52

(57) ABSTRACT

The disclosure relates to a curable mixture, in particular for use in impregnation of paper bushings, comprising (a) a resin composition comprising a bisphenol-A-diglycidylether; a polyglycidylether different from BADGE and/or a cycloaliphatic epoxy resin; a N-glycidyl component; a nano-size or dissolvable toughener; and a silane component, and b) a hardener composition comprising methyltetrahydrophthalic anhydride (MTHPA) and at least one curing accelerator as well as paper bushings impregnated with such mixture and uses of such mixture.

### TECHNICAL FIELD

The present disclosure relates to curable mixtures, in particular for use in impregnation of paper bushings, paper bushings impregnated by such mixtures as well as uses of such mixtures.

### BACKGROUND

Resin impregnated paper (RIP) bushings find use, for example, in high-voltage devices, like high voltage switchgears or transformers.

The conductive core of such a bushing is usually wound with paper, with electroplates being inserted between neighboring paper windings. The curable liquid resin/hardener mixture is then introduced into the assembly for impregnation of the paper and cured subsequently.

There are numerous patents related to such RIP bushings, for example, EP 1 798 740 A1.

U.S. Pat. No. 3,271,509 A describes electrical insulating material and bushings comprising layers of cellulosic sheet material containing 0.02-10 wt. % of a mixture of melamine and dicyandiamide, wherein the ratio of melamine:dicyandiamide is 1-5:1-4, bound together with an infusible mass resulting from the reaction of an epoxy resin with 10-60 parts maleic anhydride crosslinking agent per 100 parts epoxy resin, wherein the epoxy resin preferably is 3,4-epoxy-6-methylcyclohexylmethyl-3,4-epoxy-methylcyclo-hexane-carboxylate or dicyclopentadiene dioxide. Other crosslinking-agents may, for example, be dodecenylsuccinic, trimellitic or hexahydrophthalic anhydrides. This impregnation system, however, is rather expensive.

US 2015/0031789 A1 relates to a composite material for use in high-voltage devices having a high-voltage electrical conductor, at least partially for grading an electrical field of the high-voltage electrical conductor, and comprises a polymeric matrix and fibers embedded therein.

EP 1 907 436 A1 relates to highly filled epoxy resin compositions and their use in casting and potting processes. Such compositions can also be used for specific impregnation purposes, namely for impregnation of ignition coils. In such application, the filled system may be used in a way where the filler gets filtered out at the windings, so that only part of the neat resin can penetrate inbetween the very fine windings. The compositions described in EP 1 907 436 A1 are catalytic cured systems, where methyltetrahydrophthalic anhydride, as used in Example 3, is only used as a carrier for the sulfonium salt, and 1-methylimidazole is not used as an accelerator, but as a stabilizer for the sulfonium salt. Therefore, in such systems, methyltetrahydrophthalic anhydride is not the hardener. Rather, the sulfonium salt is the hardener triggering the homopolymerization of the epoxy resin. Such kind of chemistry would not work for impregnation of paper bushings, as it would be by far too fast and would not deliver the required smooth release of exotherm. Furthermore, the amount of methyltetrahydrophthalic anhydride per epoxy resin as given in Example 3 of EP 1 907 436 A1 is by far too low for a proper polyaddition-type curing (under-stoichiometric, as it just needs to act as a carrier for the sulfonium salt). Finally, the epoxy system according to Example 3 of EP 1 907 436 A1 would result in an unsatisfactorily low elongation at break in the magnitude of only 0.5 to 1%

It is also known to use mixtures of a bisphenol-A-diglycidylether (BADGE), methylhexahydrophthalic anhydride (MHHPA) and benzyldimethylamine (BDMA) for the production of RIP bushings. Paper bushings impregnated with such mixtures are sometimes difficult to get machined to a desired thickness and surface quality, as the cured mixtures are quite brittle which may lead to cracks. Further, this system is relatively latent meaning that it needs already a relatively high temperature to start the reaction. However, once started, the reaction is fast and may release the exothermic reaction enthalpy too quickly which may lead to local overheating with related problems, such as shrinkage and cracks.

Another known system for the production of RIP bushings is based on a BADGE, admixed with a hardener composition containing hexahydrophthalic anhydride (HHPA) and MHHPA. While this system has a lower activation energy than the one described in the previous paragraph, it is not optimal yet because of relatively low mechanical performance. Moreover, the system is relatively expensive.

For health and environmental reasons, it is, however, desired to have an impregnating system free of MHHPA, which is classified as SVHC (Substance of Very High Concern) in the REACH Regulations.

### OBJECT OF THE DISCLOSURE

The object underlying the present disclosure is to provide a cost-effective system for the impregnation of paper bushings, in particular for high-voltage applications, being free of MHHPA and any other materials currently labeled as SVHC according to the REACH regulations or as toxic according to the Globally Harmonized System of Classification and Labelling of Chemicals, and overcoming the previously discussed problems of known systems by providing higher toughness and leading to a smoother release of the exothermic heat while maintaining all other necessary critical quality aspects for RIP applications, including for example, a T_{g} of 120 to 130° C., a tan delta at 50 Hz of <0.3% at 23° C., a viscosity of <250 mPas at 40° C., an activation energy (determined via gel times measured at 80° C. and 140° C.) of <55 kJ/mol, a tensile strength of >80 MPa, an elongation at break of >3.5%, a K_{IC}>0.7 MPa·m^{0.5} and a G_{IC} of >150 J/m².

### DISCLOSURE

Unless otherwise defined herein, technical terms used in connection with the present disclosure shall have the meanings that are commonly understood by those having ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the present disclosure pertains. All patents, published patent applications, and non-patent publications referenced in any portion of this application are herein expressly incorporated by reference in their entirety to the same extent as if each individual patent or publication was specifically and individually indicated to be incorporated by reference to the extent that they do not contradict the instant disclosure.

All of the compositions and/or methods disclosed herein can be made and executed without undue experimentation in light of the present disclosure. While the compositions and methods of the present disclosure have been described in terms of preferred embodiments, it will be apparent to those having ordinary skill in the art that variations may be applied to the compositions and/or methods and in the steps or sequences of steps of the methods described herein without departing from the concept, spirit, and scope of the present disclosure. All such similar substitutes and modifications apparent to those skilled in the art are deemed to be within the spirit, scope, and concept of the present disclosure.

As utilized in accordance with the present disclosure, the following terms, unless otherwise indicated, shall be understood to have the following meanings.

The use of the word “a” or “an”, when used in conjunction with the term “comprising”, “including”, “having”, or “containing” (or variations of such terms) may mean “one”, but it is also consistent with the meaning of “one or more”, “at least one”, and “one or more than one”.

The use of the term “or” is used to mean “and/or” unless clearly indicated to refer solely to alternatives and only if the alternatives are mutually exclusive.

Throughout this disclosure, the term “about” is used to indicate that a value includes the inherent variation of error for the quantifying device, mechanism, or method, or the inherent variation that exists among the subject(s) to be measured. For example, but not by way of limitation, when the term “about” is used, the designated value to which it refers may vary by plus or minus ten percent, or nine percent, or eight percent, or seven percent, or six percent, or five percent, or four percent, or three percent, or two percent, or one percent, or one or more fractions therebetween.

The use of “at least one” will be understood to include one as well as any quantity more than one, including but not limited to, 1, 2, 3, 4, 5, 10, 15, 20, 30, 40, 50, 100, etc. The term “at least one” may extend up to 100 or 1000 or more depending on the term to which it refers. In addition, the quantities of 100/1000 are not to be considered as limiting since lower or higher limits may also produce satisfactory results.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The phrases “or combinations thereof” and “and combinations thereof” as used herein refers to all permutations and combinations of the listed items preceding the term. For example, “A, B, C, or combinations thereof” is intended to include at least one of: A, B, C, AB, AC, BC, or ABC and, if order is important in a particular context, also BA, CA, CB, CBA, BCA, ACB, BAC, or CAB. Continuing with this example, expressly included are combinations that contain repeats of one or more items or terms such as BB, AAA, CC, AABB, AACC, ABCCCC, CBBAAA, CABBB, and so forth. The skilled artisan will understand that typically there is no limit on the number of items or terms in any combination, unless otherwise apparent from the context. In the same light, the terms “or combinations thereof” and “and combinations thereof” when used with the phrases “selected from” or “selected from the group consisting of” refers to all permutations and combinations of the listed items preceding the phrase.

The phrases “in one embodiment”, “in an embodiment”, “according to one embodiment”, and the like generally mean the particular feature, structure, or characteristic following the phrase is included in at least one embodiment of the present disclosure, and may be included in more than one embodiment of the present disclosure. Importantly, such phrases are non-limiting and do not necessarily refer to the same embodiment but, of course, can refer to one or more preceding and/or succeeding embodiments. For example, in the appended claims, any of the claimed embodiments can be used in any combination.

As used herein, the term “ambient temperature” refers to the temperature of the surrounding work environment (e.g., the temperature of the area, building or room where the curable composition is used), exclusive of any temperature changes that occur as a result of the direct application of heat to the curable composition to facilitate curing. The ambient temperature is typically between about 10° C. and about 30° C., more specifically about 15° C. and about 25° C. The term “ambient temperature” is used interchangeably with “room temperature” herein.

Turning to the present disclosure, the aforementioned object is solved by a curable mixture, in particular for use in impregnation of paper bushings, comprising:
a) a resin composition comprising a bisphenol-A-diglycidylether (BADGE); a polyglycidylether different from BADGE and/or a cycloaliphatic epoxy resin; a N-glycidyl component; a nano-size or dissolvable toughener; and a silane component, and
b) a hardener composition comprising methyltetrahydrophthalic anhydride (MTHPA) and at least one curing accelerator in an amount of 0.1 to 0.001 pbw per 100 pbw of the hardener composition.

In one particular embodiment, the hardener composition comprises 99.9 to 99.999 pbw MTHPA per 100 pbw of the hardener composition.

In a preferable embodiment, the epoxy index of the BADGE according to ISO 3001 is in the range of 3.5 to 5.9 eq/kg, preferably, the epoxy index according to ISO 3001 of the BADGE is in the range between 5.0 and 5.9 eq/kg.

In a preferred embodiment, the polyglycidylether different from BADGE is selected from bisphenol-F-diglycidylether, 2,2-bis(4-hydroxy-3-methylphenyl)propane-diglycidylether, bisphenol-E-digylcidyl ether, 2,2-bis(4-hydroxyphenyl)butane-diglycidylether, bis(4-hydroxyphenyl)-2,2-dichloroethylene, bis(4-hydroxyphenyl)diphenylmethane-digylcidylether, 9,9-bis(4-hydroxyphenyl)fluorene-digylcidyl-ether, 4,4′-cyclohexylidenebisphenol-digylcidylether, epoxy phenol novolac, epoxy cresol novolac, or combinations thereof.

In another preferred embodiment, the cycloaliphatic epoxy resin is selected from bis(epoxycyclohexyl)-methylcarboxylate, or hexahydrophthalicacid-diglycidylester, bis(4-hydroxycyclo-hexyl)methane-diglycidylether, 2,2-bis(4-hydroxycyclohexyl)-propane-diglycidylether, tetrahydrophthalicacid-diglycidylester, 4-methyltetrahydrophtalicacid-diglycidylester, 4-methylhexahydrophthalicacid-diglycidylester, or combinations thereof.

In a further embodiment, the N-glycidyl component is selected from N,N,N′,N′-tetraglycidyl-4,4′-methylene-bis-benzeneamine, N,N,N′,N′-tetraglycidyl-3,3′-diethyl-4,4′-diaminodiphenylmethane, 4,4′-methylene-bis[N,N-bis(2,3-epoxypropyl)aniline], 2,6-dimethyl-N,N-bis[(oxiran-2-yl)methyl]aniline, or combinations thereof.

In another embodiment, the nano-size toughener is selected from (i) a block-copolymer with silicone and organic blocks and/or (ii) nano-sized SiO₂ particles in epoxy resin.

Alternatively, the dissolvable toughener may be selected from (i) a toughener based on polyurethanes and 4,4′-isopropylidene-bis[2-allylphenol] and/or (ii) functionalized polybutadienes.

In a further embodiment, the silane component is [3-(2,3-epoxypropoxy)-propyl]trimethoxysilane or any other epoxy-functional or amine-functional alkoxysilane.

In another embodiment of the present disclosure, the resin component additionally comprises additives, such as wetting agents, coloring agents, heat stabilizers, rheological modifiers or degassing aids.

In a preferred embodiment of the present disclosure, the ratio of the resin composition to the hardener composition is in the range of 80 to 120%, more preferably 90 to 110%, most preferably 95 to 105% related to the stoichiometric ratio of epoxy to anhydride groups in the curable mixture.

The preferred ratios of the ingredients are as follows (pbw per 100 pbw of the resin composition or per 100 pbw of the hardener composition, respectively):

resin composition
30-75 BADGE
20-50 polydiglycidylether different from BADGE
and/or cycloaliphatic epoxy resin
2-10 N-glycidyl component
2-10 nano-sized or dissolvable toughener
1-3 silane component
0-3 other additives
hardener composition
99.9-99.999 MTHPA
0.001-0.1 accelerator

Even more preferred, the ratios of the ingredients are as follows (pbw per 100 pbw of the resin composition or per 100 pbw of the hardener composition, respectively):

resin composition
45-65 BADGE
30-50 polydiglycidylether different from BADGE
and/or cycloaliphatic epoxy resin
3-7 N-glycidyl component
3-7 nano-sized or dissolvable toughener
0.5-1 silane component
0-3 other additives
hardener composition
99.9-99.999 MTHPA
0.001-0.1 accelerator

The present disclosure is also related to a paper bushing impregnated with the inventive curable mixture.

Preferably, the paper bushing is a bushing for high-voltage application.

Finally, the present disclosure is also related to the use of the presently disclosed curable mixture as an impregnating system for paper bushings, in particular for high-voltage application.

Surprisingly, the solution proposed by the present disclosure results in a system for the production of RIP bushings overcoming the problems of prior art systems as set forth hereinabove.

In particular, the system is free of SHVCs, such as MHHPA, and other materials labeled as toxic according to the Globally Harmonized System of Classification and Labelling of Chemicals, such as Accelerator DY 062 accelerator. Moreover, the specific resin composition allows obtaining the desired material characteristics as set forth hereinabove. Finally, the use of very low amounts of curing accelerators allows optimized control of the reaction.

Besides bisphenol-A-diglycidylether (BADGE) as a main resin component, the resin composition contains additional components as described in more detail as follows.

The polyglycidylether different from BADGE may be any liquid or solid glycidylether obtainable from the reaction of an aromatic or cycloaliphatic compound with at least two free alcoholic and/or phenolic hydroxyl groups and epichlorhydrin or β-epichlorhydrin under alkaline conditions or in the absence of an acidic catalyst and with a subsequent alkaline treatment.

The polyglycidylethers of this type can be derived from monoring phenols, such as resorcinol or hydroquinone, or they are based on multiring phenols, such as bis(4-hydroxyphenyl)-methane, 4,4′-dihydroxybiphenyl, bis-4-hydroxyphenyl-sulfone, 1,1,2,2-tetrakis-4-hydroxyphenyl-ethane, 2,2-bis(4-hydroxyphenyl)-propane or 2,2-bis(3,5-dibromo-4-hydroxyphenyl)-propane, as well as from novolacs, obtainable by condensation of aldehydes, such as formaldehyde, acetaldehyde, chloral or furfuraldehyde, with phenols, such as phenol, or with phenols substituted on the ring by chlorine atoms or C₁₋ to C₉-alkyl groups, such as 4-chlorophenol, 2-methylphenol or 4-tert-butylphenol, or by condensation with bisphenols, such as those mentioned hereinabove.

The polyglycidylethers of this type may, however, also be derived from cycloaliphatic alcohols, such as 1,4-cyclohexanedimethanol, bis(4-hydroxycyclohexyl)-methane or 2,2-bis(4-hydroxycyclohexyl)-propane, or they have aromatic rings, such as N,N-bis(2-hydroxyethyl)-aniline or p,p′-bis(2-hydroxyethylamino)-diphenylmethane.

Preferred examples of such polyglycidylethers to be used in the context of the present disclosure are: bisphenol-F-diglycidyl ether, 2,2-bis(4-hydroxy-3-methylphenyl)propane-diglycidylether, bisphenol-E-digylcidyl ether, 2,2-bis(4-hydroxyphenyl)-butane-diglycidylether, bis(4-hydroxyphenyl)-2,2-dichloro-ethylene, bis(4-hydroxyphenyl)diphenyl-methane-digylcidylether, 9,9-bis(4-hydroxyphenyl)-fluorene-digylcidylether, 4,4′-cyclohexylidenebisphenol-digylcidylether, epoxy phenol novolac and epoxy cresol novolac.

The cycloaliphatic epoxy resin, which can be used instead of or in addition to the polyglycidylether different from BADGE, may be any of this group of compounds. “Cycloaliphatic epoxy resin” in the context of the present disclosure means any epoxy resin with cycloaliphatic structural units, meaning that it comprises both cycloaliphatic glycidyl compounds and β-methylglycidyl compounds as well as epoxy resins on the basis of cycloalkeneoxides.

Suitable cycloaliphatic glycidyl compounds and β-methylglycidyl compounds are the glycidyl and β-methylglycidylesters of cycloaliphatic polycarboxylic acids, such as tetrahydrophthalic acid, 4-methyltetrahydrophthalic acid, hexahydrophthalic acid, 3-methylhexahydrophthalic acid and 4-methylhexahydrophthalic acid.

Further suitable cycloaliphatic epoxy resins are the dicglycidylethers and β-methylglycidylethers of cycloaliphatic alcohols, such as 1,2-dihydroxycyclohexane, 1,3-dihydroxycyclohexane and 1,4-dihydroxycyclohexane, 1,4-cyclohexanedimethanol, 1,1-bis(hydroxymethyl)-cyclohex-3-ene, bis(4-hydroxycyclohexyl)-methane, 2,2-bis(4-hydroxycyclohexyl)-propane and bis(4-hydroxycyclohexyl)-sulfone.

Examples of epoxy resins with cycloalkeneoxide structures are bis(2,3-epoxycyclopentyl)ether, 2,3-epoxycyclopentyl-glycidylether, 1,2-bis(2,3-epoxycyclopentyl)ethane, vinyl-cyclohexenedioxide, 3,4-epoxycyclohexylmethyl-3′,4′-epoxy-cyclohexanecarboxylate, 3,4-epoxy-6-methylcyclohexylmethyl-3′,4′-epoxy-6′-methylcyclohexanecarboxylate, bis(3,4-epoxy-cyclohexylmethyl)adipate and bis(3,4-epoxy-6-methylcyclo-hexylmethyl)adipate.

Preferred cycloaliphatic epoxy resins are bis(4-hydroxycyclohexyl)methane-diglycidylether, 2,2-bis(4-hydroxy-cyclohexyl)propan-diglycidylether, tetrahydrophthalicacid-diglycidylester, 4-methyltetrahydrophthalicacid-diglycidyl-ester, 4-methylhexahydrophthalicacid-diglycidylester, 3,4-epoxycyclohexylmethyl-3′-,4′-epoxycyclohexanecarboxylate, hexahydrophthalicacid-diglycidylester, and combinations thereof.

The N-glycidyl component may also be any from this group of compounds. N-glycidyl components of this type are obtainable by dehydrochlorination of reaction products of epichlorhydrin with aromatic amines containing at least two amine hydrogen atoms. These amines may be aniline, bis(4-aminophenyl)methane, m-xylylenediamine or bis(4-methylaminophenyl)methane. It is, however, also possible to use epoxy resins wherein the 1,2-epoxy groups are bound to different heteroatoms or functional groups; amongst those compounds are the N,N,O-triglycidyl derivate of the 4-aminophenol or the glycidylether-glycidylester of salicylic acid.

Typical examples are N,N,N′,N′-tetraglycidyl-4,4′-methylenebisbenzeneamine, N,N,N′,N′-tetraglycidyl-3,3′-dimethyl-4,4′-diaminediphenylmethane, 4,4′-methylene-bis-[N,N-bis-(2,3-epoxypropyl)aniline] or 2,6-dimethyl-N,N-bis-[(oxiran-2-yl)methyl]aniline.

The nano-size toughener used in the resin composition of the present disclosure may, for example, be a block-copolymer with silicone and organic blocks (for example Genioperl® W35 from Wacker Chemie AG, Munich, Germany) or nano-sized SiO₂ particles in epoxy resin (for example Nanopox® E470 from Evonik Industries, Essen, Germany. The organic blocks in the block-copolymer may, for example, be based on caprolactone or other lactones.

Examples for a dissolvable toughener are Flexibilizer DY 965 from Huntsman Corporation or an affiliate thereof (The Woodlands, Tex.) (see below) or functionalized polybutadienes (for example, a toughener on the basis of carboxyl-terminated butadiene-acrylonitrile (CTBN)).

The silane component of the resin composition of the present disclosure is preferably [(3-(2,3-epoxypropoxy)-propyl]trimethoxysilane, however, the silane component may also be any other epoxy-functional alkoxy-silane, such as 3-glycidyloxypropyltriethoxysilane, or any other silane reactive with epoxy, such as amine-functional alkoxysilanes, such as 3-aminopropyltriethoxysilane.

The MTHPA used in the presently disclosed hardener composition may be any isomer of MTHPA or mixtures thereof in a purity of >99%.

The curing accelerators, which can be used in very low amounts in the presently disclosed hardener composition, may be any typical curing accelerator for epoxy/anhydrides, such as 2,4,6-tris(dimethylaminomethyl)phenol (Accelerator DY 067 from Huntsman Corporation or an affiliate thereof), imidazoles, boronhalogenide-amine complexes, Zn-salts of any organic acid (for example, Zn-neodecanoate, Zn-naphthenate), tertiary alkylamine aminoethylalcohols or their corresponding ethers, such as, for example, JEFFCAT® ZF-10 catalyst (N,N,N′-trimethyl-N′-hydroxyethyl-bisaminoethylether), JEFFCAT® ZR-50 catalyst (N,N-bis(3-dimethylaminopropyl)-N-isopropanolamine), JEFFCAT® ZR-70 catalyst (2-(2-dimethylaminoethoxy)ethanol, JEFFCAT® ZR-110 catalyst (N,N,N′-trimethyl-aminoethyl-ethanolamine), JEFFCAT® DPA catalyst (N-(3-dimethylaminopropyl)-N,N-diisopropanolamine) or JEFFCAT® DMEA catalyst (N,N-dimethylethanolamine) (all JEFFCAT® catalysts available from Huntsman Corporation or an affiliate thereof). Preferably, the curing accelerator is not a sulfonium salt.

In one embodiment, the composition is substantially free of sulfonium salts.

In one particular embodiment, the at least one curing accelerator is present in the hardener composition in an amount of from 0.1 to 0.001 pbw per 100 pbw of the hardener composition.

The main application of the presently disclosed system is for impregnation of paper bushings to obtain RIPs. It may, however, also be useful for other electrical applications that target to avoid MHHPA and/or HPPA, for example, as a basic material for cast resin type high-voltage bushings and lower-voltage bushings and switchgear parts or insulating parts.

More details and advantages will become obvious from the following examples. The components, which are all available from Huntsman Corporation or an affiliate thereof, with the exception of Genioperl® W35 and Silquest™ A-187 silane (from Momentive Performance Materials, Albany, N.Y.), used therein are as follows:
1. Araldite® MY 740 resin: BADGE with an epoxy index of 5.0-5.9 eq/kg
2. Aradur® HY 1102 hardener: MHHPA
3. Accelerator DY 062 accelerator: Benzyldimethylamine
4. XB 5860: Resin formulation based on BADGE, containing between 3-7 wt. % 4,4′-methylene-bis[N,N-bis(2,3-epoxypropyl)aniline]
5. Aradur® HY 1235 hardener: Mixture of HHPA and MHHPA
6. Araldite® LY 556: BADGE with an epoxy index of 5.30-5.45 eq/kg
7. Aradur® HY 918-1 hardener: Mixture of various isomers of MTHPA having a viscosity of 50-80 mPas at 25° C. according to ISO 12058
8. JEFFCAT® ZF-10 catalyst: N,N,N′-trimethyl-N′-hydroxy-ethyl-bisaminoethylether
9. Accelerator DY 067 accelerator: 2,4,6-tris(dimethylaminomethyl)phenol
10. Flexibilizer DY 965 toughener: toughener based on polyurethanes and 4,4′-isopropylidene-bis[2-allylphenol]
11. Araldite® EPN 1138 resin: epoxy-phenol-novolac with an epoxy index of 5.5-5.7 eq/kg
12. Araldite® CY 179-1 resin: bis-(epoxycyclohexyl) methylcarboxylate
13. Araldite® MY 9512 resin: N,N,N′,N′-tetraglycidyl-4,4′-methylene-bisbenzeneamine
14. Araldite® PY 302-2 resin: mix of BADGE/BFDGE with an epoxy index of 5.65-5.90 eq/kg
15. Araldite® GY 280 resin: bisphenol-A-epoxy resin with an epoxy index of 3.57-4.45 eq/kg
16. Genioperl® W35: block-copolymer with silicone and organic blocks
17. Silquest A 187 silane: [(3-(2,3-epoxypropoxy)-propyl]trimethoxysilane

### Comparative Example 1 (BADGE/MHHPA/BDMA)

200 g of Araldite® MY 740 resin were put into a metal reactor. Then 180 g of Aradur® HY 1102 and 0.1 g of Accelerator DY 062 accelerator were added. The components were then mixed with an anchor stirrer at ambient temperature for about 15 min. Finally, the mixture was subjected to a vacuum to remove all or substantially all bubbles from the mixture.

The mixture was then used to determine its viscosity and gel time.

A portion of the mixture was cast into molds (preheated to 80° C.) to prepare test specimens for the mechanical and electrical tests.

The molds were subjected to curing conditions of 12 h at 80° C.+16 h at 130° C.

After cooling to ambient temperature, Tg, mechanical and electrical properties were determined according to standard procedures as set forth herein.

### Comparative Example 2 (Araldite® MY 740 Resin/Aradur® HY 918-1 Hardener/0.05 pbw BDMA)

200 g of Araldite® MY 740 resin were put into a metal reactor. Then 170 g of Aradur® HY 918-1 hardener and 0.05 g of Accelerator DY 062 accelerator were added. The components were then mixed with an anchor stirrer at ambient temperature for about 15 min. Finally, the mixture was subjected to a vacuum to remove all or substantially all bubbles from the mixture.

The mixture was then used to determine its viscosity and gel time.

A portion of the mixture was cast into molds (preheated to 80° C.) to prepare test specimens for the mechanical and electrical tests.

The molds were subjected to curing conditions of 12 h at 80° C.+16 h at 130° C.

After cooling to ambient temperature, Tg, mechanical and electrical properties were determined according to standard procedures.

### Comparative Example 3 (XB 5860/Aradur® HY 1235 Hardener)

200 g of XB 5860 were put into a metal reactor. Then 170 g of Aradur® HY 1235 hardener were added. The components were then mixed with an anchor stirrer at ambient temperature for about 15 min. Finally, the mixture was subjected to a vacuum to remove all or substantially all bubbles from the mixture.

The mixture was then used to determine viscosity and gel time.

A portion of the mixture was cast into molds (preheated to 80° C.) to prepare test specimens for the mechanical and electrical tests.

The molds were subjected to curing conditions of 6 h at 100° C.+12 h at 140° C.

After cooling to ambient temperature, Tg, mechanical and electrical properties were determined according to standard procedures.

### EXAMPLE 1

### Preparation of Resin A-1

60.450 g of Araldite® LY 556 resin was heated to 90° C. Then 3.9 g of Genioperl® W35 was added and dissolved in the resin while stirring the mixture for 30 min at 90° C. The mixture was then cooled to 60° C. 20 g of Araldite® EPN 1138 resin, 10 g of Araldite® CY 179-1 resin and 5 g of Araldite® MY 9512 resin was added and mixed all together at 60° C. for 5 min. Finally, 0.65 g of Silquest™ A 187 silane was added and stirred in for 10 min to obtain Resin A-1.

### Preparation of Hardener B

99.2 g of Aradur® HY 918-1 hardener was mixed with 0.8 g of Accelerator DY 067 accelerator at room temperature while stirring for 5 min to obtain Masterbatch B.

99 g of Aradur® HY 918-1 hardener was added to exactly 1.0 g of Masterbatch B and mixed together while stirring for 5 min to obtain Hardener B (containing 0.008% Accelerator DY 067 accelerator).

To the 100 g of Resin A-1, 95 g of Hardener B was added and all the components were then mixed with an anchor stirrer at ambient temperature for about 15 min. Finally, the mixture was subjected to a vacuum to remove all or substantially all bubbles from the mixture.

The mixture was then used to determine its viscosity and gel times.

A part of the mixture was cast into molds (preheated to 80° C.) to prepare test specimens. The molds were put to a curing program of 12 h at 80° C.+16 h at 130° C.

After cooling to ambient temperature, Tg, mechanical and electrical properties were determined according to standard procedures.

### EXAMPLE 2

### Preparation of Resin A-2

30 g of Araldite® GY 280 resin (pre-heated to ca. 60° C.) were put into a heatable mixing vessel. Then 46.50 g of Araldite® PY 302-2 resin, 13.0 g Araldite® CY 179-1 resin, 5.0 g Araldite® MY 9512 resin, and 5 g of Flexibilizer DY 965 toughener were added. All components were mixed together for 10 min while heating up to 60° C. After cooling to 40° C., 0.50 g of Silques™ A 187 silane was added and stirred in while 10 min to obtain Resin A-2.

To the 100 g of Resin A-2, 85 g of Hardener B (see Example 1) were added and all the components were then mixed with an anchor stirrer at ambient temperature for about 15 min. Finally, the mixture was subjected to a vacuum to remove all or substantially all bubbles.

The mixture was then used to determine its viscosity and gel times.

A part of the mixture was cast into molds (preheated to 80° C.) to prepare test specimens. The molds were put to a curing program of 12 hours at 80° C.+16 hours at 130° C.

After cooling to ambient temperature, Tg, mechanical and electrical properties were determined according to standard procedures.

The formulations as well as the results of the various measurements are shown in Table 1 below.

TABLE 1

| | Components | | | | |
|---|---|---|---|---|---|
| Properties | Comp. 1 | Comp. 2 | Comp. 3 | Ex. 1 | Ex. 2 |
| Araldite ® | 100 | 100 | — | — | — |
| MY 740 resin | | | | | |
| (g) | | | | | |
| Aradur ® HY | 90 | — | — | — | — |
| 1102 hardener | | | | | |
| (g) | | | | | |
| Accelerator DY | 0.05 | 0.05 | — | — | — |
| 062 accelerator | | | | | |
| (g) | | | | | |
| Aradur ® HY | — | 85 | — | — | — |
| 918-1 hardener | | | | | |
| (g) | | | | | |
| XB 5860 | — | — | 100 | — | — |
| (g) | | | | | |
| Aradur ® HY | — | — | 85 | — | — |
| 1235 hardener | | | | | |
| (g) | | | | | |
| Resin A-1 | — | — | — | 100 | — |
| (g) | | | | | |
| Hardener B | — | — | — | 95 | 85 |
| (g) | | | | | |
| Resin A-2 | — | — | — | — | 100 |
| (g) | | | | | |
| Gel time 80° C. | 1258 | 1638 | 1100 | 739 | 676 |
| (min) | | | | | |
| Gel time 140° | 34.5 | 35.7 | 150 | 55.7 | 48.8 |
| (min) | | | | | |
| Ea | 72.6 | 77.3 | 40.2 | 52.2 | 53.1 |
| (KJ/mol) | | | | | |
| Tg | 123 | 104 | 125 | 122 | 123 |
| (° C.) | | | | | |
| Tensile Strength | 67 | 64 | 44 | 90 | 94 |
| (MPa) | | | | | |
| Elongation Break | 2.7 | 2 | 1.4 | 4.1 | 4.4 |
| (%) | | | | | |
| K1C | 0.59 | 0.66 | 0.60 | 0.78 | 0.72 |
| (MPa · m^{1/2}) | | | | | |
| G1C | 114 | 123 | 94 | 189 | 159 |
| (J/m²) | | | | | |
| MHHPA-free | No | Yes | No | Yes | Yes |
| Tox-free | No | No | Yes | Yes | Yes |
| Impregnation | Good | Good | Good | Good | Good |

Note:
In the “Tox-free” line of the Table, “Yes” means that no DY 062, labelled as toxic, was used, and “No” means that DY 062 was used.

Gel times were determined with a Gel Norm instrument according to ISO 9396.

Tensile strength and elongation at break were determined at 23° C. according to ISO R527.

K_{IC} (critical stress intensity factor) in MPa·m^{0.5} and G_{IC} (specific break energy) in J/m² were determined at 23° C. by double torsion experiment.

Tg was determined according to ISO 11357-2.

Impregnation was tested by putting 25 filter papers (type MN 713, 70 mm diameter) together and pressing them together on a plate using a ring with an internal diameter of 5.5 cm. This set up was preheated to 80° C. in an oven. Then 10 g of test system (room temperature) were poured on the filters. The whole set up was put to the oven for 8 hours at 80° C. and 10 hours at 130° C. After curing, it was checked, how many of the 25 filters got impregnated by the material. If all got impregnated, then the impregnation capability was rated as “good”, otherwise as “poor”.

The activation energy Eₐ was calculated this way:

Eₐ=(ln((gel time at 80° C.)/min.)−ln((gel time at 140° C.)/min.))/(1/(80° C.*1K/° C.+273K)−1/(140° C.*1K/° C.+273K))*8.31 J/(mol*K)/1000 J/kJ

Comparative Example 1 shows the most widely used system in industry: BADGE/MHHPA/BDMA.

The main problems of this reference system are the REACH issues about MHHPA and the fact that Accelerator DY 062 is regarded to be toxic according to the Globally Harmonized System of Classification and Labelling of Chemicals.

Further, there is a need to improve the mechanical performance and a too latent reaction (high activation energy of 72.6 J/mol): Once the reaction got started (for this it needs a high temperature), it processes then too quickly (for certain applications) and releases the exothermic heat too quickly. If the reaction is started e.g. at 100° C. in a 500 g experiment, then the temperature rise would go up to 117.8° C. The difference between reaction start temperature and maximum temperature should be lower to cause less stress.

Comparative Example 2 shows the most narrow idea to solve the REACH problem of Comparative Example 1 by replacing MHHPA by MTHPA. While the REACH issue would be solved, there are still problems of this system because of Accelerator DY 062, which is regarded to be toxic, the fact that the Tg is by far too low, that the mechanical properties are still poor, and that the reaction is even more latent than in Comparative Example 1 (Eₐ=77.3 kJ/mol). The temperature rise in the exothermic experiment would go even up to 121.1° C.

Comparative Example 3 shows XB 5860/Aradur® HY 1235 hardener. This system is indeed much better in terms of heat release due to a much lower activation energy. However, it remains to have a REACH issue with Aradur® HY 1235 hardener and the mechanical properties is even worse than in Comparative Example 1.

Example 1 is an example of a REACH-compliant, tox-free system with superior mechanical properties compared to the systems of Comparative Examples 1-3 and showing a low activation energy. Thus, the heat release in the exothermic experiment rises the temperature only up to 112.1° C.

This system according to the present disclosure meets all the requirements as listed hereinabove.

As the activation energy is low, it may also need only a lower temperature to start the reaction thus leading to an even lower peak temperature.

Example 2 is another example of the realization of the present disclosure, with a quite different composition as Example 1, however, leading to a quite similar performance profile like: REACH compliance, tox-free, sufficiently high Tg, far better mechanical properties compared to all reference systems, and lower activation temperatures and thus smoother release of the exothermic heat and good impregnation capability.

The above-disclosed subject matter is to be considered illustrative, and not restrictive, and the appended claims are intended to cover all such modifications, enhancements, and other embodiments, which fall within the true scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A curable mixture comprising
a) a resin composition comprising a bisphenol-A-diglycidylether (BADGE); a polyglycidylether different from BADGE and/or a cycloaliphatic epoxy resin; a N-glycidyl component; a nano-sized or dissolvable toughener; and a silane component, and
b) a hardener composition comprising methyltetrahydrophthalic anhydride and at least one curing accelerator, wherein the at least one curing accelerator is present in an amount of 0.1 to 0.001 pbw per 100 pbw of the hardener composition.

2. The curable mixture according to claim 1, wherein the epoxy index according to ISO 3001 of the BADGE is in a range between 3.5 and 5.9 eq/kg

3. The curable mixture according to claim 2, wherein the epoxy index according to ISO 3001 of the BADGE is in a range between 5.0 and 5.9 eq/kg.

4. The curable mixture according to claim 1, wherein the polyglycidylether different from BADGE is selected from bisphenol-F-diglycidylether, 2,2-bis(4-hydroxy-3-methylphenyl)propane-diglycidylether, bisphenol-E-digylcidylether, 2,2-bis(4-hydroxyphenyl)-butane-diglycidylether, bis(4-hydroxyphenyl)-2,2-dichloro-ethylene, bis(4-hydroxyphenyl)diphenyl-methane-digylcidylether, 9,9-bis(4-hydroxyphenyl)-fluorene-digylcidylether, 4,4′-cyclohexylidenebisphenol-digylcidylether, epoxy phenol novolac, epoxy cresol novolac or combinations thereof.

5. The curable mixture according to claim 1, wherein the cycloaliphatic epoxy resin is selected from bis-(epoxycyclohexyl)-methylcarboxylate or hexahydrophthalic acid diglycidylether, bis(4-hydroxycyclohexyl)methane-diglycidylether, 2,2-bis(4-hydroxycyclohexyl)propane-diglycidylether, tetrahydrophthalicacid-diglycidylester, 4-methyltetrahydrophtalicacid-diglycidylester, 4-methylhexahydrophthalicacid-diglycidylester or combinations thereof.

6. The curable mixture according to claim 1, wherein the N-glycidyl component is selected from N,N,N′,N′-tetraglycidyl-4,4′-methylene-bis-benzeneamine, N,N,N′,N′-tetraglycidyl-3,3′-diethyl-4,4′-diaminodiphenylmethane, 4,4′-methylene-bis-[N,N-bis-(2,3-epoxypropyl)aniline], 2,6-dimethyl-N,N-bis[(oxiran-2-yl)methyl]aniline or combinations thereof.

7. The curable mixture according to claim 1, wherein the nano-sized toughener is selected from (i) a block-copolymer with silicone and organic blocks and/or (ii) nano-sized SiO₂ particles in epoxy resin.

8. The curable mixture according to claim 1, wherein the dissolvable toughener is selected from (i) a toughener based on polyurethanes and 4,4′-isopropylidene-bis[2-allylphenol] and/or (ii) functionalized polybutadienes.

9. The curable mixture according to claim 1, wherein the silane component is [3-(2,3-epoxypropoxy)-propyl]trimethoxysilane or any other epoxy-functional or amine-functional alkoxysilane.

10. The curable mixture according to claim 1, wherein the ratio of resin composition to hardener composition is in a range of from 80 to 120% related to the stoichiometric ratio of epoxy to anhydride groups in the curable mixture.

11. The curable mixture according to claim 10, wherein the ratio of resin composition to hardener composition is in a range of from 90 to 110% related to the stoichiometric ratio of epoxy to anhydride groups in the curable mixture.

12. The curable mixture according to claim 11, wherein the ratio of resin composition to hardener composition is in a range of from 95 to 105% related to the stoichiometric ratio of epoxy to anhydride groups in the curable mixture.

13. A paper bushing impregnated with the curable mixture according to claim 1.

14. The paper bushing according to claim 13, wherein the paper bushing is a bushing for high-voltage application.

15. (canceled)
